(19) United States
(12) Patent Application Publication
(10) Pub. No.: US 2026/0193912 A1
(43) Pub. Date: Jul. 9, 2026

(54) CATCH MECHANISM TO SECURE DOOR LOCK FRAME COVER

(71) Applicant: Hampton Products International Corporation, Foothill Ranch, CA (US)

(72) Inventor: Chasen Beck, Garden Grove, CA (US)

(21) Appl. No.: 19/012,555

(22) Filed: Jan. 7, 2025

(51) Int. Cl. E05C 1/08; E05B 49/00

(52) U.S. Cl. CPC E05C 1/08; E05B 49/00

(57) ABSTRACT

A deadbolt door lock includes a deadbolt assembly and a mounting plate, and can also include a lock interior assembly or further components. The mounting plate includes a slidable latch that is biased, and movable to receive a hook of the lock interior assembly. The mounting plate and the slidable latch have functionality to retain the seated lock interior assembly to the mounting plate while one or more fasteners are operated to secure the lock interior assembly to the mounting plate.

### TECHNICAL FIELD

The technical field of the present disclosure relates to mechanical latches, catches, and securing mechanisms, and relates to door locks, more specifically deadbolt door locks, still more specifically keypad or electronically operated deadbolt door locks.

### BACKGROUND

Deadbolt door locks and other types of door locks provide security for homes, businesses, owners and occupants thereof. Designers and manufacturers of door locks strive for security, durability, and also ease of installation of the product. Yet, with the number of components involved, and the various mechanisms of the product and interactions with tools used in installation, many users resort to hiring professional installers. Even with professional installers, there is a need for improvement in ease of installation, as the components of a given door lock must be assembled in situ, to a door, where parts can be dropped, misplaced, or damaged. An improvement in ease of installation may require fewer hands (or personnel), cost a customer less due to time savings in paying a professional installer, or may result in more users with confidence to install a door lock without need of a professional installer. Therefore, there is a need in the art for a solution which overcomes the drawbacks described above.

### SUMMARY

According to one aspect, the disclosure is directed to a deadbolt door lock. The deadbolt door lock comprises a deadbolt latch assembly having a deadbolt that is movable to lock and unlock a door, and a mounting plate that is mountable to the deadbolt latch assembly from an interior side of the door. The mounting plate includes a slidable latch that is biased to a slidable latch extended position, movable by a hook, against such bias to a slidable latch retracted position, to receive the hook during installation of a lock interior assembly, the lock interior assembly having the hook and arrangement for one or more fasteners, and movable with such bias to a hook retaining position proximate to or equal to the slidable latch extended position during seating of the lock interior assembly to the mounting plate. The slidable latch is configured to retain the seated lock interior assembly to the mounting plate while the one or more fasteners are operated to secure the lock interior assembly to the mounting plate.

In some embodiments, the lock interior assembly can snap onto the mounting plate and be supported onto the mounting plate by the slidable latch, and the slidable latch retains the hook of the lock interior assembly and retains the seated lock interior assembly to the mounting plate.

In some embodiments, the mounting plate further includes a boss that is threaded to receive a threaded fastener, and the slidable latch includes an elongated aperture that is dimensioned and oriented to have the threaded fastener mount the slidable latch to the boss and mount the slidable latch to the mounting plate.

In some embodiments, the deadbolt door lock further comprises a spring, assembled to the mounting plate with the slidable latch, to provide such bias.

In some embodiments, the mounting plate further includes a tab to which to mount a spring, and the slidable latch includes a further tab, to which to mount the spring, to provide such bias.

In some embodiments, the deadbolt door lock further comprises an exterior keypad assembly, mountable to the deadbolt latch assembly from an exterior side of the door, and the mounting plate is securable through the deadbolt latch assembly to the exterior keypad assembly when the mounting plate is mounted to the deadbolt latch assembly from the interior side of the door.

In some embodiments, the deadbolt door lock further comprises the lock interior assembly, comprising a battery compartment, and a further cover mountable to the lock interior assembly to enclose the battery compartment.

In some embodiments, the slidable latch includes two tabs to guide motion of the slidable latch, and the mounting plate further includes two elongated apertures to engage the two tabs of the slidable latch.

In some embodiments, the mounting plate further includes a recess located to receive a portion of the hook of the lock interior assembly.

According to another aspect, the disclosure is directed to a deadbolt door lock. The deadbolt door lock comprises a deadbolt latch assembly having a deadbolt that is movable to a deadbolt retracted position and movable to a deadbolt extended position, a mounting plate that is mountable to the deadbolt latch assembly from an interior side of a door, and a lock interior assembly having a hook and mountable to the mounting plate. The mounting plate includes a slidable latch that is spring-biased to a hook-latching position and movable by the hook of the lock interior assembly to a hook-receiving position, to receive the hook during installation of the lock interior assembly and then latch the hook. The slidable latch is configured to retain the lock interior assembly to the mounting plate with the slidable latch in the hook-latching position, prior to and during securing of the lock interior assembly to the mounting plate with one or more fasteners.

In some embodiments, the slidable latch is operable so that the lock interior assembly can snap onto the mounting plate and be latched thereto.

In some embodiments, the mounting plate further includes a boss with internal thread, the slidable latch includes an elongated aperture to receive the boss, and a threaded fastener is configured to mount the slidable latch to the boss and to the mounting plate.

In some embodiments, the mounting plate further includes a tab, the slidable latch includes a further tab, and a spring is assembled to the tab of the mounting plate and the further tab of the slidable latch, to provide such spring-bias.

In some embodiments, the deadbolt door lock further comprises an exterior keypad assembly, having a keypad for operation of the deadbolt, and the mounting plate is securable through the deadbolt latch assembly to the exterior keypad assembly.

In some embodiments, the deadbolt door lock further comprises the lock interior assembly having a battery compartment, and a cover mountable to the lock interior assembly to enclose the battery compartment.

In some embodiments, the slidable latch includes two tabs, and the mounting plate further includes two elongated apertures to engage the two tabs of the slidable latch to guide motion of the slidable latch.

In some embodiments, the mounting plate further includes a recess to receive the hook.

According to yet another aspect, the disclosure is directed to a deadbolt door lock. The deadbolt door lock comprises an exterior keypad assembly, a deadbolt latch assembly, a lock interior assembly having a hook, and a mounting plate having a slidable latch that is biased towards a latching position. The mounting plate is configured to secure, through the deadbolt latch assembly, to the exterior keypad assembly. The mounting plate and the slidable latch are configured to receive and latch the hook of the lock interior assembly, to retain the lock interior assembly to the mounting plate so that the lock interior assembly can be securely attached with one or more fasteners.

In some embodiments, the lock interior assembly is configured to snap onto the mounting plate and be supported on the mounting plate by the slidable latch.

In some embodiments, the slidable latch has a first tab to retain a spring that provides such bias, and the slidable latch has second and third tabs to engage respective apertures of the mounting plate to guide motion of the slidable latch.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a mounting plate (which may also be termed a frame), in an embodiment used for a door lock, more specifically a deadbolt door lock, still more specifically a keypad or electronically operated deadbolt door lock.

FIG. 2 illustrates a slidable latch, in an embodiment that is used in combination with the mounting plate of FIG. 1, or variation thereof.

FIG. 3 illustrates a side perspective view of the slidable latch of FIG. 2.

FIG. 4 illustrates an assembly of the mounting plate of FIG. 1, the slidable latch of FIG. 2, a spring providing bias to the slidable latch, and a fastener mounting the slidable latch to the mounting plate, in an embodiment.

FIGS. 5-11 illustrate assembly of a door lock, more specifically a keypad or electronically operated deadbolt door lock, in an embodiment that uses the frame or mounting plate with slidable latch, of FIGS. 1-4.

FIG. 5 illustrates a deadbolt latch assembly, mounted in a door, ready to receive exterior and interior components in further assembly of a door lock, in an embodiment.

FIG. 6 illustrates installation of an exterior keypad assembly, in an embodiment.

FIG. 7 illustrates the deadbolt latch assembly of FIG. 5 as seen from an interior side of the door, ready to receive the frame or mounting plate with slidable latch, in an embodiment.

FIG. 8 illustrates installation of the frame or mounting plate with slidable latch, with two fasteners securing the frame or mounting plate to the deadbolt latch assembly and the exterior keypad assembly. For example, screws or other fasteners may go through clearance holes of the deadbolt latch assembly, so that the interior latch assembly becomes secured to the exterior keypad assembly by such fasteners.

FIG. 9 illustrates a lock interior assembly, in an embodiment that has a hook, in further installation of the door lock.

FIG. 10 illustrates the lock interior assembly of FIG. 9 engaging the frame or mounting plate with slidable latch, in further installation of the door lock, in an embodiment.

FIG. 11 illustrates use of a tool to operate two fasteners to secure a lock interior assembly of FIG. 9 to the frame or mounting plate, and thus to the deadbolt latch assembly and exterior keypad assembly, with the slidable latch retaining the seated lock interior assembly to the frame or mounting plate.

FIGS. 12A-12C illustrate the slidable latch engaging the hook of the lock interior assembly, and retaining the hook of the lock interior assembly, in a side view of an embodiment.

FIG. 12A illustrates the hook of the lock interior assembly, pressing on and moving the slidable latch from a latch extended position, to open the latch.

FIG. 12B illustrates the hook of the lock interior assembly pressing on and holding the slidable latch in an open position or retracted position, as the hook moves towards a hook-retaining position of the hook so that the latch can retain the hook of the lock interior assembly.

FIG. 12C illustrates the hook of the lock interior assembly in a hook-retaining position, with the slidable latch moving to a hook-retaining position of the slidable latch, which may also be termed an extended position, to close the latch.

### DETAILED DESCRIPTION

Described herein are various embodiments of a door lock, components of a door lock including a lock interior assembly and mounting plate or frame, and a latch or catch mechanism to secure a lock interior assembly to a mounting plate or frame. Although embodiments are described of a deadbolt door lock, more specifically a keypad or electronically operated deadbolt door lock, with a lock interior assembly and a catch mechanism featuring a slidable latch, the principles and embodiments are generalizable to other types of door locks, including other types of deadbolt door locks. The various embodiments include a technological improvement over previously tried and used mechanisms for temporarily or removably retaining a lock interior assembly to a frame or mounting plate. This improves upon installation time and troubles, for a door lock.

Conventional mechanisms used in installation and assembly of a door lock, that is to say, previously tried and used approaches, have shortcomings. For example, a frame hook, a recess, a protrusion or other non-moving, passive or mechanically inactive structure may engage a protrusion, an edge or other portion of a lock interior assembly but fail to reliably hold the lock interior assembly in place to a mounting plate or frame in situ while an installer obtains and uses a tool, such as a screwdriver, wrench, power tool with bit, etc. The installer may find he wishes he had three hands or a further assistant to hold the lock interior assembly while fasteners are operated by the installer with the tool to install and secure the lock interior assembly. With an unreliable, finicky, temporary retention mechanism, the lock interior assembly may fall, move, displace, misalign, dangle from one fastener, or otherwise interfere with successful, smooth, uneventful, efficient installation and securing of the lock interior assembly. Embodiments described herein improve thereupon, retaining the lock interior assembly to the frame or mounting plate, for example, while fastener(s) are operated to secure the lock interior assembly to the frame or mounting plate.

One purpose, goal for and function achieved by present embodiments is to provide a mounting plate or frame with improved catch mechanism and a lock interior assembly that can snap onto the mounting plate or frame and be supported onto the frame by the improved latch or catch mechanism.

In some embodiments, the mounting plate or frame has a slidable latch (which may also be termed a catch) that is mounted to the body of the mounting plate or frame. In some embodiments, both the mounting plate or frame and the latch or catch have a tab for supporting a helical coil spring. In some embodiments, the mounting plate or frame has two longitudinal slots and the latch or catch has two longitudinal tabs that slide within the slots of the mounting plate or frame.

In one embodiment, the mounting plate or frame has a boss with an internal screw thread and the latch or catch has a slot which receives the boss when the latch or catch is mounted to the mounting plate or frame. The latch or catch is held to the mounting plate or frame by a fastener with a wide, flat head to prevent any rolling movement. Of course, any rolling movement depends on the height of the boss and the thickness of the latch or catch. When the fastener is fastened to the boss, the gap between the screw head must be larger than the thickness (width) of the latch or catch to allow the latch or catch to freely slide.

In some embodiments, the catch has a chamfered end and a slot or recess within the chamfered end. In some embodiments, the lock interior assembly has a hook (which may be termed a tab), that when placed to the frame, pushes the latch or catch against the bias of the spring until the hook or tab slips into the slot or recess, and the catch or latch snaps over the hook or tab preventing the lock interior assembly from pulling out from the frame.

Variations may be devised by the person of skill in the art, in keeping with the teachings herein. Specific embodiments are described below, and it is understood that various features, variations thereof and combinations thereof may be combined in various further embodiments.

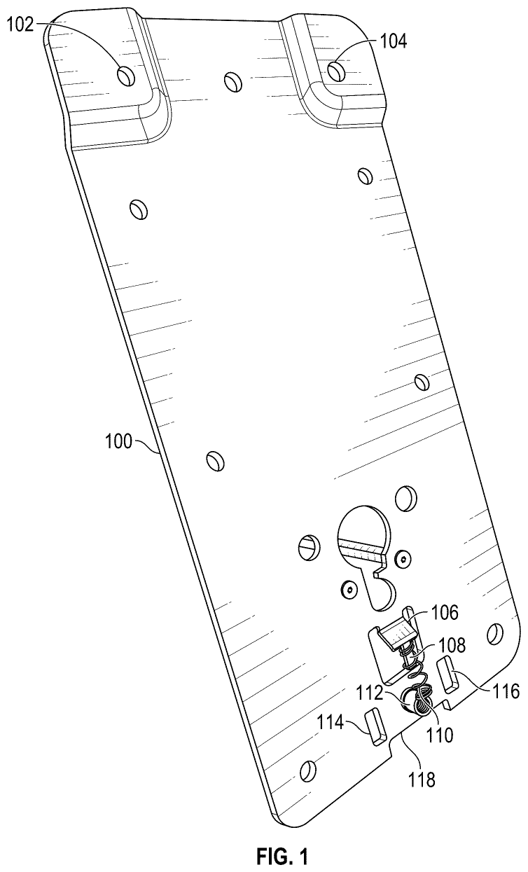

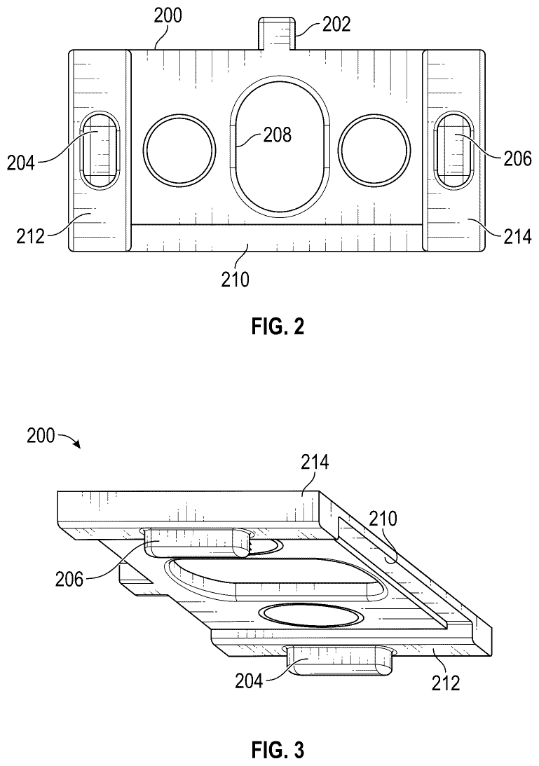

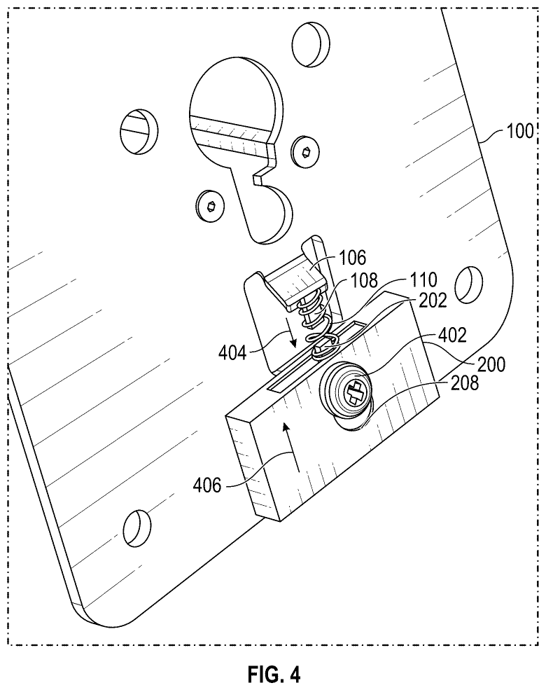

FIG. 1 illustrates a mounting plate 100 (which may also be termed a frame), in an embodiment used for a door lock, more specifically a deadbolt door lock, still more specifically a keypad or electronically operated deadbolt door lock. Further components and assembly thereof are described below in detail. The mounting plate has two apertures 102, 104, which may be threaded to receive threaded fasteners. Alternatively, threaded inserts may be used or additional threaded pieces such as nuts, etc. For mounting a slidable latch (see FIGS. 2-4), the mounting plate 100 has a boss 112, which may be a threaded insert. For biasing the slidable latch, the mounting plate has a feature for mounting a spring 110. In this example, there is a displaced protrusion 106 with a tab 108, extending from the mounting plate and oriented towards the boss 112. The tab 108 is dimensioned to receive and retain a spring 110, for example by press-fit or loose assembly (see FIG. 4). There are two elongated apertures 114, 116, adjacent to the boss 112, and these are dimensioned to receive mechanical features of the slidable latch, to align and constrain movement of the slidable latch. A recess 118 of the mounting plate 100, adjacent to the boss 112 and elongated apertures 114, 116, is dimensioned to receive a mechanical feature of a lock interior assembly for retention, more specifically a hook or a portion of a hook. Other apertures, fittings (e.g., posts) and features of the mounting plate 100 may be defined and executed for purposes of fitting, receiving, aligning or mounting other components as specific to an embodiment, etc. For example, the land surrounding the two apertures 102, 104 is displaced from the planar arrangement of the majority of the body of the mounting plate 100, and may facilitate alignment or retention of a lock interior assembly. More specifically, such displacement may cooperate with the slidable latch in alignment and retention of a lock interior assembly.

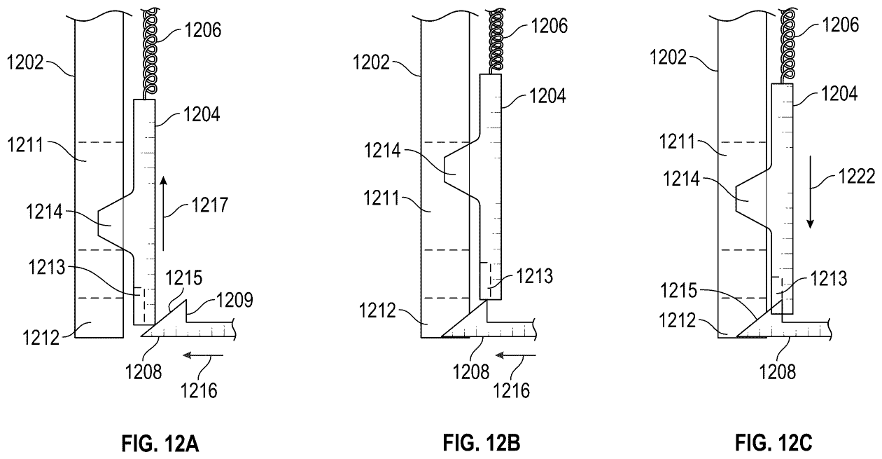

FIG. 2 illustrates a slidable latch 200, in an embodiment that is used in combination with the mounting plate 100 of FIG. 1, or variation thereof. The slidable latch 200 may be made from a cast or molded metal, or stamped, or built up. In the embodiment shown, the slidable latch 200 has a tab 202 arranged and dimensioned to fit a spring for biasing the slidable latch (see FIG. 4). There are two tabs 204, 206, extending from respective tab support regions 212, 214 of the slidable latch 200. In this embodiment, each of the two tabs 204, 206 is arranged and dimensioned to engage the respective aperture 102, 104 of the mounting plate 100, in movable or slidable arrangement. That is, the elongated apertures 102, 104 of the mounting plate 100 engage and guide movement of the two tabs 204, 206 of the slidable latch 200. In some embodiments, the support regions 212, 214 are raised or otherwise displaced from a main surface of the slidable latch 200, for example to slide and reduce frictional engagement of the slidable latch 200 relative to the mounting plate 100. There is an aperture 208 in the slidable latch 200, which may be elongated and dimensioned to slidably engage with the boss 112 of the mounting plate 100. Thus, in some embodiments, the elongated aperture 208 cooperates with the boss 112, and the two tabs 204, 206 cooperate with the elongated apertures 102, 104 of the mounting plate 100, to constrain and guide the movement of the slidable latch 200 in a linear, to and fro, direction and motion (see, e.g., FIGS. 4 and 12A-12C). In the embodiment shown, an edge region 210 of the slidable latch 200 is chamfered or thinned, for example to provide for dimensions and operation of a hook of the lock interior assembly, e.g. as a recess or lip for a portion of such a hook to engage.

FIG. 3 illustrates a side perspective view of the slidable latch 200 of FIG. 2. Closer to the viewer, one tab 206 is seen extending below a tab support region 214. Farther from the viewer, one tab 204 is seen extending below a tab support region 212. To the right in the view, the chamfered, thinned or recessed edge region 210 of the slidable latch 200 is seen, e.g., as an engagement lip of the slidable latch 200.

FIG. 4 illustrates an assembly of the mounting plate 100 of FIG. 1, the slidable latch 200 of FIG. 2, a spring 110 providing bias to the slidable latch 200, and a fastener 402 mounting the slidable latch 200 to the mounting plate 100, in an embodiment. This arrangement may be termed a slidable latch assembly. Here, the spring 110 is assembled to and retained by the tab 108 of the mounting plate 100 and the tab 202 of the slidable latch 200, with the spring 110 in slight compression providing bias in an extension direction 404 to the slidable latch 200. Moving the slidable latch 200 in a retraction direction 406 opposes the bias of the spring 110, and can compress the spring 110. A portion of the elongated aperture 208 of the slidable latch 200 is visible past an edge of the fastener 402 (or possibly, a washer in association with the fastener 402), showing how movement and displacement of the slidable latch 200 is constrained by the boss 112 and the elongated aperture 208.

It is appreciated that the extended position of the slidable latch 200 is a default position of the slidable latch 200, without a lock interior assembly installed, and the slidable latch 200 can go through a retracted position and a further extended position in the process of latching to a hook of the lock interior assembly, as illustrated and discussed below. It is further appreciated that the spring 110 provides spring-bias to the slidable latch 200 and contributes to retention of the hook of the lock interior assembly during installation.

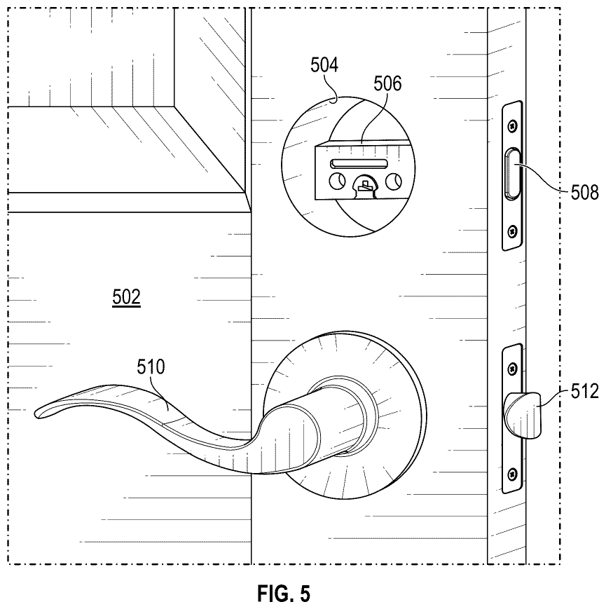

FIGS. 5-11 illustrate assembly of a door lock, more specifically a keypad or electronically operated deadbolt door lock, in an embodiment that uses the frame or mounting plate 100 with slidable latch 200, of FIGS. 1-4.

FIG. 5 illustrates a deadbolt latch assembly 506, mounted in a door 502, ready to receive exterior and interior components in further assembly of a door lock, in an embodiment. This is an exterior view, as from the outside of a building or outside of a room, with the door 502 slightly ajar so as to make visible the deadbolt 508 of the deadbolt latch assembly 506, and a latch 512 operated by an external doorknob 510 separately from the deadbolt 508 and deadbolt latch assembly 506. Note that the deadbolt 508 is in a retracted position relative to the deadbolt latch assembly 506 and the door 502, to unlock the door. And, the deadbolt 508 may be operated (e.g., moved) to an extended position (not shown), to lock the door. A circular aperture 504 is shown through the door 502, within which can be seen a visible portion of the deadbolt latch assembly 506, and it is understood other apertures are arranged for passage of the deadbolt, and mounting and operation of the external doorknob 510 and door latch 512.

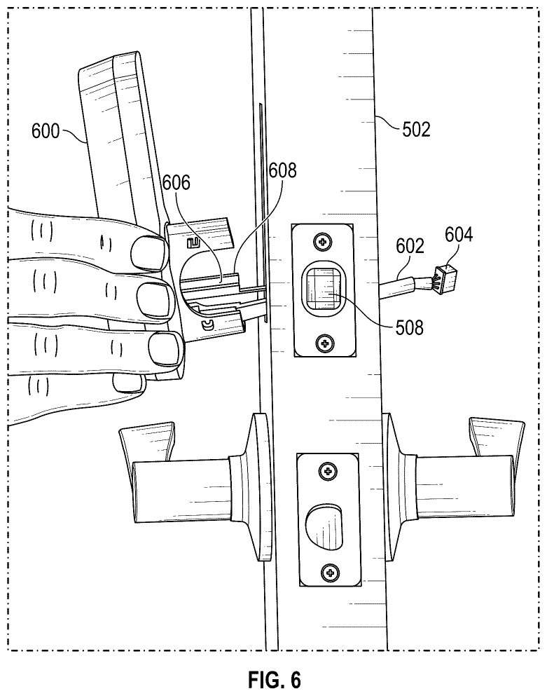

FIG. 6 illustrates installation of an exterior keypad assembly 600, in an embodiment. For example, the exterior keypad assembly 600 could have a keypad, with which a user may enter an unlocking sequence, or a locking sequence, etc., for operating an electronic deadbolt door lock. Here, a wire 602 with connector 604 has been passed through the deadbolt latch assembly 506, as will be two mounting posts 606, 608 of the exterior keypad assembly 600. The posts 606, 608 may be threaded posts, and/or may be termed prongs. The deadbolt 508 is visible at the outward opening edge of the door 502.

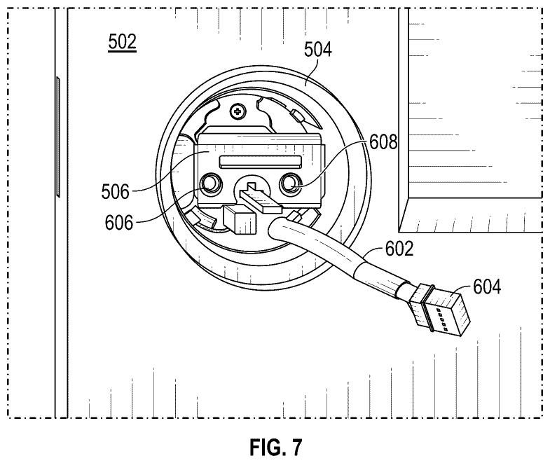

FIG. 7 illustrates the deadbolt latch assembly 506 of FIG. 5 as seen from an interior side of the door 502, ready to receive the frame or mounting plate 100 with slidable latch 200, in an embodiment. Through the aperture 504 in the door 502, the deadbolt latch assembly 506 and receiving ends of the two mounting posts 606, 608 of the exterior keypad assembly 600 are visible. Also visible are the wire 602 and connector 604, which will be used for electrical connection.

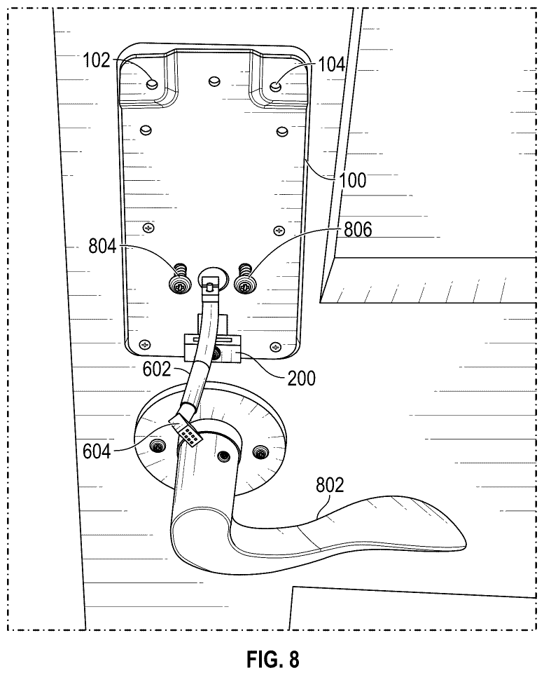

FIG. 8 illustrates installation of the frame or mounting plate 100 with slidable latch 200, with two fasteners 804, 806 securing the frame or mounting plate to the deadbolt latch assembly 506 and the exterior keypad assembly 600. For example, screws or other fasteners may go through clearance holes of the deadbolt latch assembly 506, so that the lock interior assembly becomes secured to the exterior keypad assembly by such fasteners. Posts and fasteners may help align to the deadbolt latch assembly while not securing directly to the deadbolt latch assembly 506. Particularly, although not visible in this drawing, the fasteners 804, 806 are understood to assemble to the mounting posts 606, 608 of the exterior keypad assembly 600 and thereby secure the frame or mounting plate 100, the deadbolt latch assembly 506 and the exterior keypad assembly 600 to one another as a further assembly in situ, in a door 502. An interior doorknob 802 is visible below this assembly.

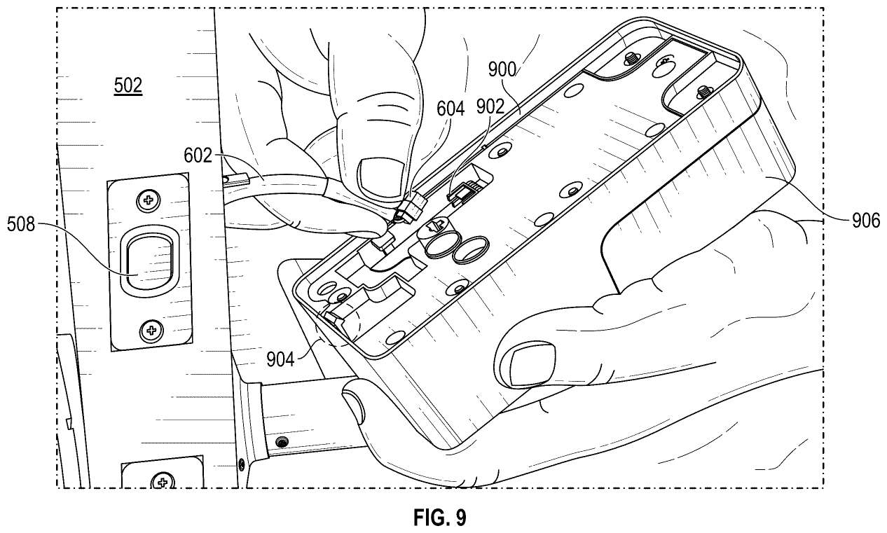

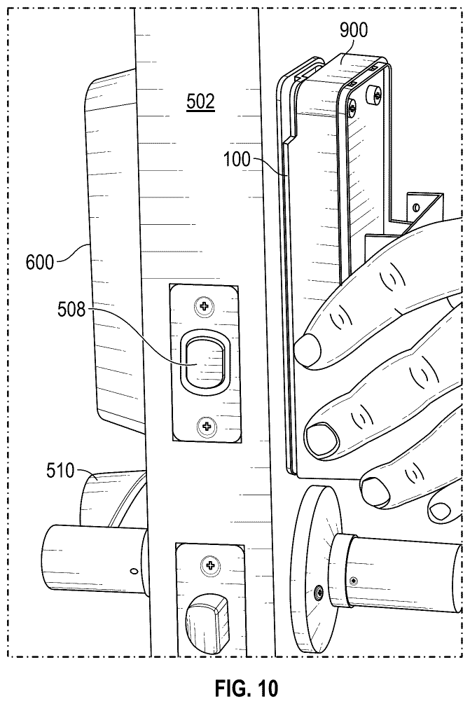

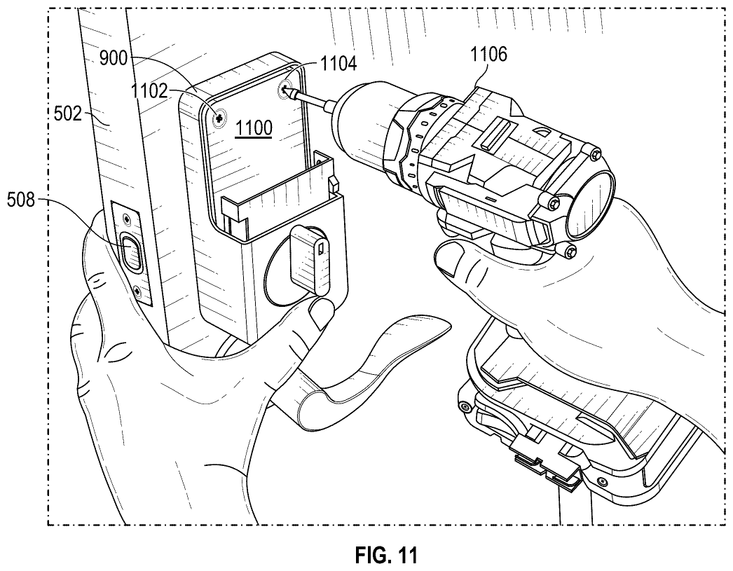

FIG. 9 illustrates a lock interior assembly 900, in an embodiment that has a hook 904, in further installation of the door lock. For example, the lock interior assembly 900 may include a body, housing or cover, electronics such as circuitry and/or a processor, an electric actuator such as a motor or solenoid to drive mechanical actuation of the deadbolt, etc. The hook may be attached to or integral with one of the components of the lock interior assembly 900, for example a body, housing or cover, in various embodiments. In this embodiment, the lock interior assembly 900 has a battery compartment, and a battery compartment cover 906 is shown in place attached to the lock interior assembly 900. A user, for example an installer, is shown attaching the connector 604 of the wire 602, to a connector port 902 of the lock interior assembly 900, in advance of installing the lock interior assembly 900 as shown in FIGS. 10 and 11.

FIG. 10 illustrates the lock interior assembly 900 of FIG. 9 engaging the frame or mounting plate 100 with slidable latch 200, in further installation of the door lock, in an embodiment. The user is aligning the door-facing surface of the lock interior assembly 900 to the frame or mounting plate 100 and pressing, which engages the hook 904 of the lock interior assembly 900 to the slidable latch 200 (see FIGS. 4, 9, also FIGS. 12A-12C). It is appreciated further alignment features of the lock interior assembly 900 may engage further alignment features of the frame or mounting plate 100.

FIG. 11 illustrates use of a tool 1106 to operate two fasteners to secure a lock interior assembly 900 of FIG. 9 to the frame or mounting plate 100, and thus to the deadbolt latch assembly 506 and exterior keypad assembly 600, with the slidable latch 200 retaining the seated lock interior assembly 900 to the frame or mounting plate 100. In this example, the tool 1106 is a power tool with a screwdriver bit, and unpowered tools such as a screwdriver or other tools for other types of fasteners are readily envisioned as variations. Although it is here pictured that the user applies a thumb to the lock interior assembly 900 for holding in place, it is intended (and found in practice) the slidable latch 200 retains the lock interior assembly 900 to the mounting plate 100, with the slidable latch in the hook-latching position, prior to and during securing of the lock interior assembly to the mounting plate with the fastener(s) 1102, 1104, i.e., one or more fastener. That is, the user's thumb (or other manual assistance) is optional for holding, and the slidable latch 200 is operable so that the lock interior assembly 900 can snap onto the mounting plate 100 and be latched. This demonstrates retention improvement in comparison to a non-movable hook retention.

FIGS. 12A-12C illustrate the slidable latch 1204 engaging the hook of the lock interior assembly, and retaining the hook 1208 of the lock interior assembly (not shown, see FIG. 9), in a side view of an embodiment.

FIG. 12A illustrates the hook 1208 of the lock interior assembly (not shown, see FIG. 9), pressing on and moving the slidable latch 1204 from a latch extended position, to open the latch. Here, the hook 1208 is shown moving in a latch engaging direction 1216, and a beveled or angled face 1210 of the hook is pressing on part of the slidable latch 1204, causing the slidable latch 1204 to move in a latch opening or retracting direction 1217, against bias from a spring 1206. A tab 1214 of the slidable latch 1204 mates to and is guided by a recess, groove or aperture 1211 of the mounting plate 1202. In some embodiments, a recess 1212 of the mounting plate 1202 is available to receive a forward (or distal) end of the hook 1208. See, for example, the recess 118 of the mounting plate 100, in FIG. 1. This feature could also be implemented as a pocket, depression, or a thinned or chamfered region, in further embodiments.

FIG. 12B illustrates the hook 1208 of the lock interior assembly pressing on and holding the slidable latch 1204 in an open position or retracted position, as the hook 1208 moves towards a hook-retaining position of the hook 1208 so that the latch can retain the hook of the lock interior assembly. The hook 1208 continues to move in a latch engaging direction 1216, and here the forward or distal end of the hook 1208 is received in the recess 1212 of the mounting plate 1202. In variations, the chamfered or thinned edge region 1213 of the slidable latch 1204 is dimensioned for close fit to the back side 1209 of the ramp 1215 of the hook 1208, for a close fitting, close tolerances latch.

FIG. 12C illustrates the hook 1208 of the lock interior assembly in a hook-retaining position, with the slidable latch 1204 moving to a hook-retaining position of the slidable latch 1204, which may also be termed an extended position, to close the latch. As the ramp 1215 of the hook clears the chamfered or thinned edge region 1213 of the slidable latch 1204, the slidable latch 1204 moves in an extension direction 1222, and the hook 1208 is retained by the slidable latch 1204.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A deadbolt door lock comprising:
a deadbolt latch assembly having a deadbolt that is movable to lock and unlock a door; and
a mounting plate that is mountable to the deadbolt latch assembly from an interior side of the door;
wherein:
the mounting plate includes a slidable latch that is:
biased to a slidable latch extended position;
movable by a hook, against such bias to a slidable latch retracted position, to receive the hook during installation of a lock interior assembly, the lock interior assembly having the hook and arrangement for one or more fasteners; and
movable with such bias to a hook retaining position proximate to or equal to the slidable latch extended position during seating of the lock interior assembly to the mounting plate; and
the slidable latch is configured to retain the seated lock interior assembly to the mounting plate while the one or more fasteners are operated to secure the lock interior assembly to the mounting plate.

2. The deadbolt door lock of claim 1, wherein:
the lock interior assembly can snap onto the mounting plate and be supported onto the mounting plate by the slidable latch; and
the slidable latch retains the hook of the lock interior assembly and retains the seated lock interior assembly to the mounting plate.

3. The deadbolt door lock of claim 1, wherein:
the mounting plate further includes a boss that is threaded to receive a threaded fastener; and
the slidable latch includes an elongated aperture that is dimensioned and oriented to have the threaded fastener mount the slidable latch to the boss and mount the slidable latch to the mounting plate.

4. The deadbolt door lock of claim 1, further comprising:
a spring, assembled to the mounting plate with the slidable latch, to provide such bias.

5. The deadbolt door lock of claim 1, wherein:
the mounting plate further includes a tab to which to mount a spring; and
the slidable latch includes a further tab, to which to mount the spring, to provide such bias.

6. The deadbolt door lock of claim 1, wherein:
the deadbolt door lock further comprises an exterior keypad assembly, mountable to the deadbolt latch assembly from an exterior side of the door; and
the mounting plate is securable through the deadbolt latch assembly to the exterior keypad assembly when the mounting plate is mounted to the deadbolt latch assembly from the interior side of the door.

7. The deadbolt door lock of claim 1, further comprising:
the lock interior assembly, having a battery compartment; and
a further cover mountable to the lock interior assembly to enclose the battery compartment.

8. The deadbolt door lock of claim 1, wherein:
the slidable latch includes two tabs to guide motion of the slidable latch; and
the mounting plate further includes two elongated apertures to engage the two tabs of the slidable latch.

9. The deadbolt door lock of claim 1, wherein:
the mounting plate further includes a recess located to receive a portion of the hook of the cover.

10. A deadbolt door lock, comprising:
a deadbolt latch assembly having a deadbolt that is movable to a deadbolt retracted position and movable to a deadbolt extended position;
a mounting plate that is mountable to the deadbolt latch assembly from an interior side of a door; and
a lock interior assembly having a hook and mountable to the mounting plate;
wherein:
the mounting plate includes a slidable latch that is spring-biased to a hook-latching position and movable by the hook of the lock interior assembly to a hook-receiving position, to receive the hook during installation of the lock interior assembly and then latch the hook; and
the slidable latch is configured to retain the lock interior assembly to the mounting plate with the slidable latch in the hook-latching position, prior to and during securing of the lock interior assembly to the mounting plate with one or more fasteners.

11. The deadbolt door lock of claim 10, wherein:
the slidable latch is operable so that the lock interior assembly can snap onto the mounting plate and be latched thereto.

12. The deadbolt door lock of claim 10, wherein:
the mounting plate further includes a boss with internal thread;
the slidable latch includes an elongated aperture to receive the boss; and
a threaded fastener is configured to mount the slidable latch to the boss and to the mounting plate.

13. The deadbolt door lock of claim 10, wherein:
the mounting plate further includes a tab;
the slidable latch includes a further tab; and
a spring is assembled to the tab of the mounting plate and the further tab of the slidable latch, to provide such spring-bias.

14. The deadbolt door lock of claim 10, wherein:
the deadbolt door lock further comprises an exterior keypad assembly, having a keypad for operation of the deadbolt; and
the mounting plate is securable through the deadbolt latch assembly to the exterior keypad assembly.

15. The deadbolt door lock of claim 10, further comprising:
the lock interior assembly having a battery compartment; and
a cover mountable to the lock interior assembly to enclose the battery compartment.

16. The deadbolt door lock of claim 10, wherein:
the slidable latch includes two tabs; and
the mounting plate further includes two elongated apertures to engage the two tabs of the slidable latch to guide motion of the slidable latch.

17. The deadbolt door lock of claim 10, wherein:
the mounting plate further includes a recess to receive the hook.

18. A deadbolt door lock, comprising:
an exterior keypad assembly;
a deadbolt latch assembly;
a lock interior assembly having a hook; and
a mounting plate having a slidable latch that is biased towards a latching position;
wherein the mounting plate is configured to secure, through the deadbolt latch assembly, to the exterior keypad assembly, the mounting plate and the slidable latch are configured to receive and latch the hook of the lock interior assembly, to retain the lock interior assembly to the mounting plate so that the lock interior assembly can be securely attached with one or more fasteners.

19. The deadbolt door lock of claim 18, wherein:
the lock interior assembly is configured to snap onto the mounting plate and be supported on the mounting plate by the slidable latch.

20. The deadbolt door lock of claim 18, wherein:
the slidable latch has a first tab to retain a spring that provides such bias; and
the slidable latch has second and third tabs to engage respective apertures of the mounting plate to guide motion of the slidable latch.
